(19) United States
(12) Patent Application Publication
(10) Pub. No.: US 2026/0085465 A1
(43) Pub. Date: Mar. 26, 2026

(54) ACTIVE CARRIER CHANNEL FOR LINT MANAGEMENT WITHIN AN APPLIANCE

(71) Applicant: WHIRLPOOL CORPORATION, BENTON HARBOR, MI (US)

(72) Inventor: Arun Rajendran, St. Joseph, MI (US)

(73) Assignee: WHIRLPOOL CORPORATION, BENTON HARBOR, MI (US)

(21) Appl. No.: 18/895,548

(22) Filed: Sep. 25, 2024

(51) Int. Cl. D06F 58/22; B01D 46/10; B01D 46/69; B01D 46/79

(52) U.S. Cl. CPC D06F 58/22; B01D 46/10; B01D 46/69; B01D 46/79; B01D 2273/30; B01D 2279/55

(57) ABSTRACT

A laundry appliance includes a blower that delivers process air through an airflow path, an air filter having a filter media that separates particulate from the process air to define captured particulate, a fluid spray system having at least one cleaning nozzle and a carrier nozzle, and a sump that receives the stream of carrier fluid, the cleaning stream and the captured particulate. The carrier nozzle delivers a stream of carrier fluid below the air filter, and the at least one cleaning nozzle directs a cleaning stream onto the filter media. The cleaning nozzle operates after activation of the carrier nozzle to direct the captured particulate into the stream of carrier fluid.

### BACKGROUND OF THE DISCLOSURE

The present disclosure generally relates to laundry appliances, and more specifically, a lint management system for a laundry appliance that includes an active carrier channel that produces a stream of carrier fluid for directing captured lint from an air filter to a collection area, such as a sump.

### SUMMARY OF THE DISCLOSURE

According to one aspect of the present disclosure, a laundry appliance includes a blower that delivers process air through an airflow path, an air filter having a filter media that separates particulate from the process air to define captured particulate, a fluid spray system having at least one cleaning nozzle and a carrier nozzle, and a sump that receives the stream of carrier fluid, the cleaning stream and the captured particulate. The carrier nozzle delivers a stream of carrier fluid below the air filter, and the at least one cleaning nozzle directs a cleaning stream onto the filter media. The cleaning nozzle operates after activation of the carrier nozzle to direct the captured particulate into the stream of carrier fluid.

According to another aspect of the present disclosure, an air filtration assembly for an appliance includes a filter media disposed within an airflow path. The filter media separates particulate from process air within the airflow path to define captured particulate. The air filtration assembly also includes a carrier channel positioned below the filter media, and a carrier nozzle aligned with the carrier channel. The carrier nozzle is selectively operable to direct a stream of carrier fluid through the carrier channel and below the filter media. The air filtration assembly further includes a filter cleaning assembly that directs a cleaning stream onto the filter media for directing the captured particulate into the carrier channel. The filter cleaning assembly is activated only after activation of the carrier nozzle, and the carrier nozzle is deactivated after deactivation of the filter cleaning assembly. The air filtration assembly additionally includes a sump in communication with the carrier channel. The sump receives the stream of carrier fluid, the cleaning stream, and the captured particulate.

According to yet another aspect of the present disclosure, a method for operating an air filtration assembly includes the steps of activating a spray sequence to separate captured particulate from a filter media, activating a drain pump, activating a carrier nozzle to deliver a stream of carrier fluid through a carrier channel positioned below the filter media, separating the captured particulate from the filter media, delivering the captured particulate into the stream of carrier fluid, delivering the stream of carrier fluid and the captured particulate to a sump, and deactivating the carrier nozzle and the drain pump.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a laundry appliance that incorporates an aspect of the active carrier channel for transporting captured lint to a sump of the appliance;

FIG. 2 is a top perspective view of a heat exchanger housing that incorporates an aspect of the active carrier channel;

FIG. 3 is a top plan view of the heat exchanger housing of FIG. 2;

FIG. 4 is a bottom plan view of the heat exchanger housing of FIG. 2;

FIG. 5 is a side elevational view of the heat exchanger housing of FIG. 2;

FIG. 6 is another side elevational view of the heat exchanger housing of FIG. 2;

FIG. 7 is another side elevational view of the heat exchanger housing of FIG. 2;

FIG. 8 is a partially exploded perspective view of the heat exchanger housing of FIG. 2;

FIG. 9 is another partially exploded perspective view of the heat exchanger housing of FIG. 2;

FIG. 10 is a cross-sectional view of the heat exchanger housing of FIG. 3 taken along line X-X;

FIG. 11 is an enlarged cross-sectional view of the heat exchanger housing of FIG. 10, taken at area XI;

FIG. 12 is a cross-sectional view of the heat exchanger housing of FIG. 3 taken along line XII-XII;

FIG. 13 is a cross-sectional view of the heat exchanger housing of FIG. 6 taken along line XIII-XIII;

FIG. 14 is a schematic flow diagram illustrating a process for operating a fluid spray system that incorporates the active carrier channel for delivering captured lint to a sump of an appliance;

FIG. 15 is a schematic linear flow diagram illustrating a method for operating an air filtration assembly that incorporates an aspect of the active carrier channel; and

FIG. 16 is a schematic flow diagram illustrating a method for cleaning an air filter within an airflow path.

Components in the figures are not necessarily to scale, emphasizing instead being placed upon illustrating the principles described herein.

### DETAILED DESCRIPTION

The present illustrated embodiments reside primarily in combinations of method steps and apparatus components related to an active carrier channel for lint management within an appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

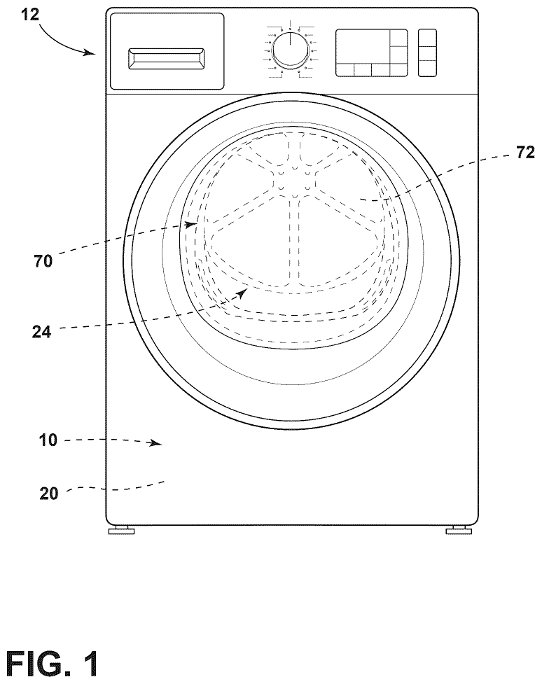

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

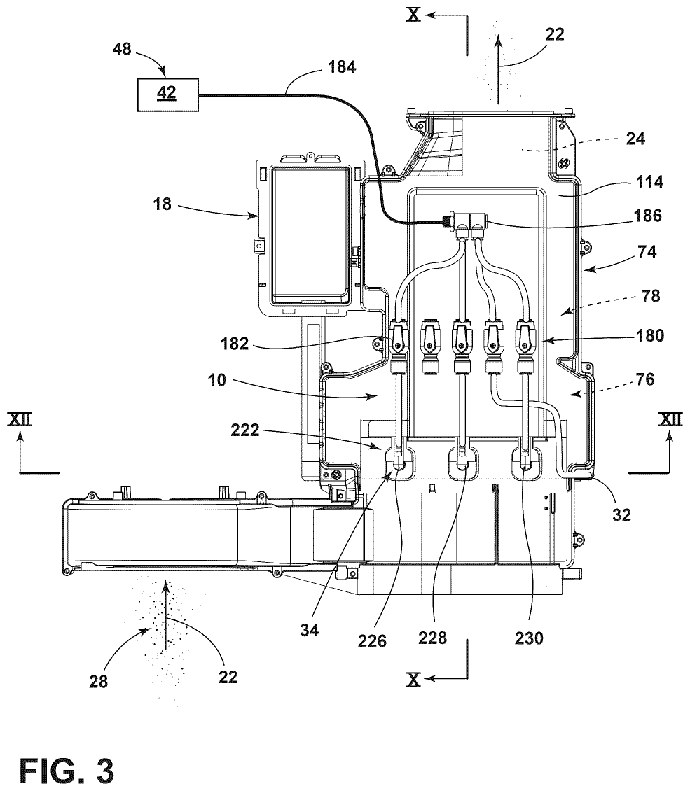

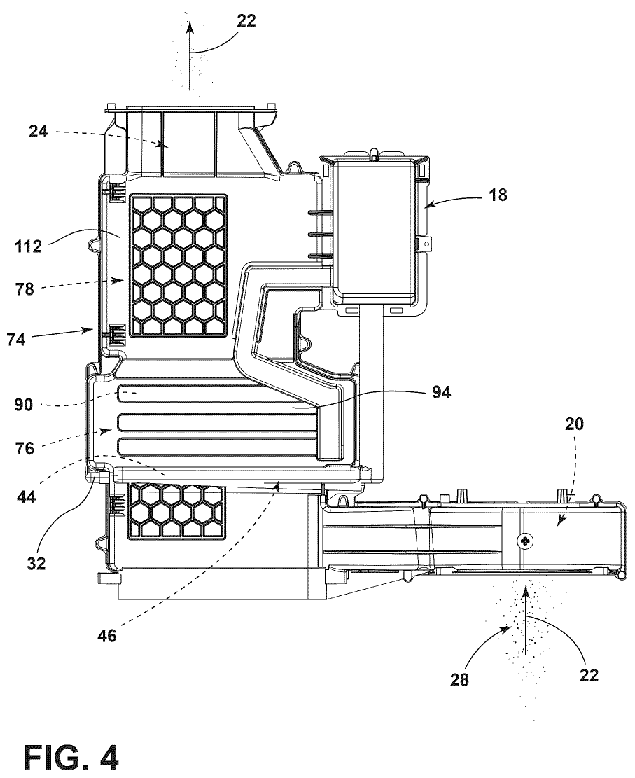

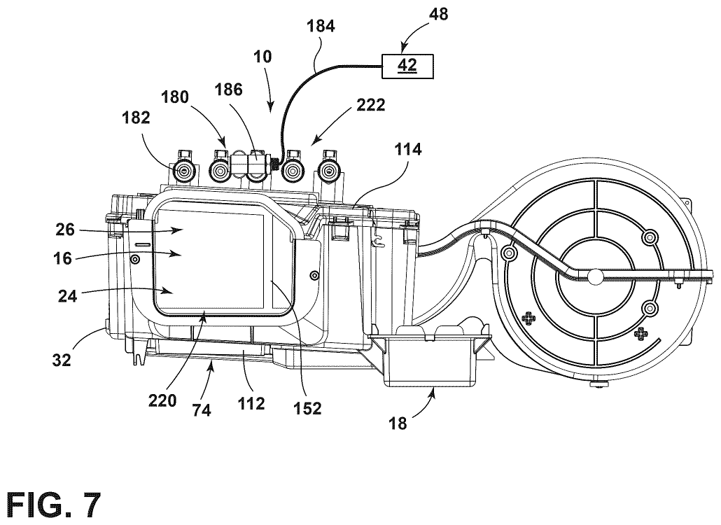

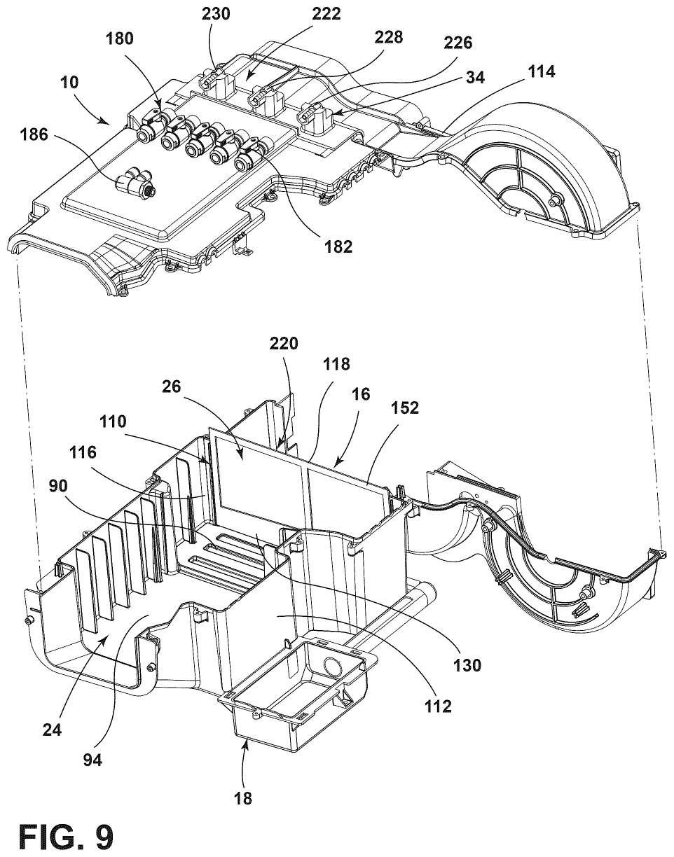

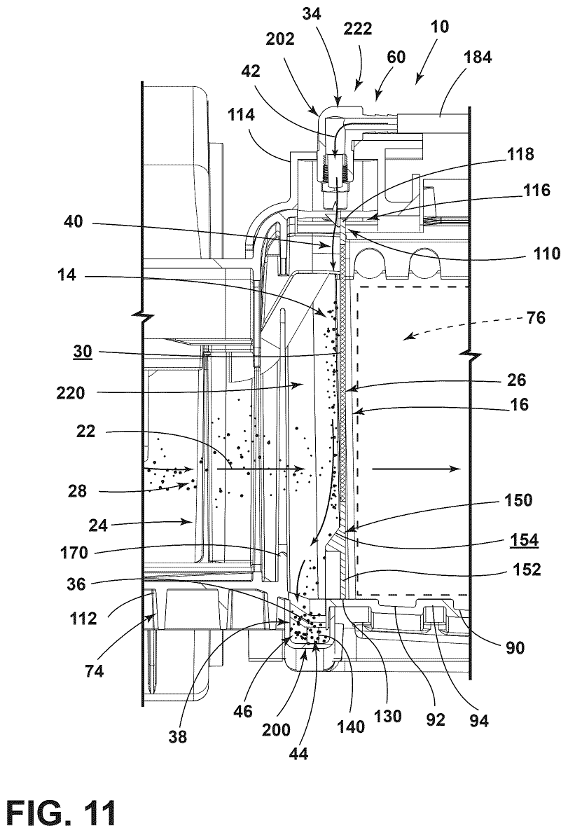

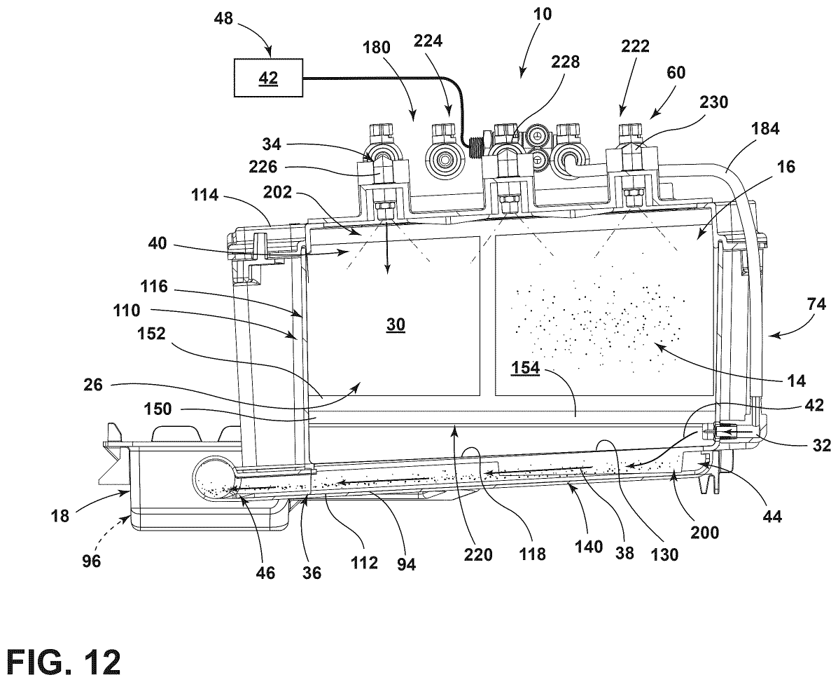

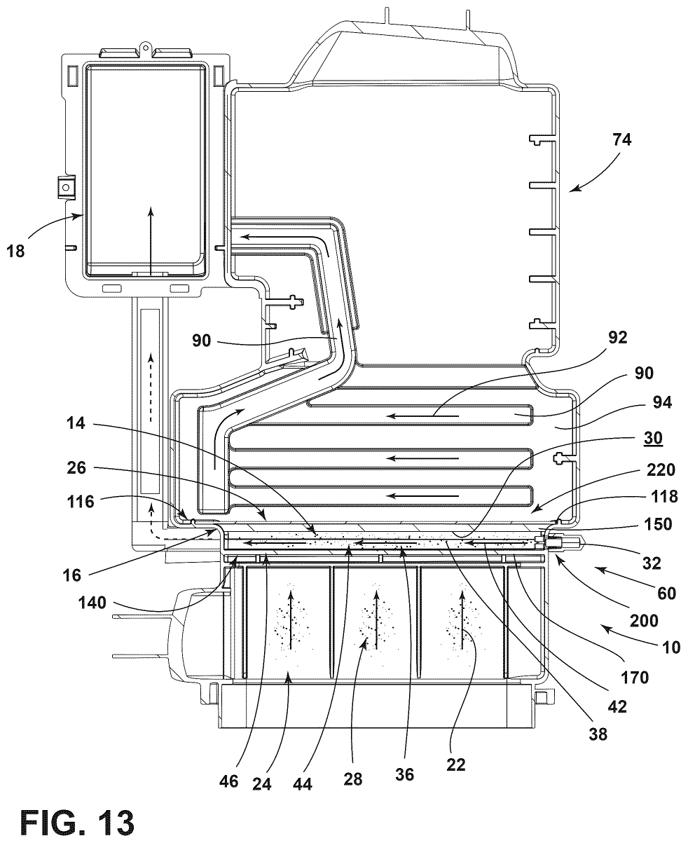

Referring to FIGS. 1-14, reference numeral 10 generally refers to a fluid spray system that is incorporated with an appliance 12 for cleaning captured particulate 14 from an air filter 16 and delivering the captured particulate 14 to a sump 18 of the appliance 12 for later disposal. According to the various aspects of the device, the appliance 12, typically a laundry appliance, includes a blower 20 that delivers process air 22 through an airflow path 24. The air filter 16 includes a filter media 26. The filter media 26 allows the process air 22 to pass therethrough and separates particulate 28 from the process air 22 to define the captured particulate 14 that is temporarily held by an upstream surface 30 of the filter media 26. The fluid spray system 10 includes a carrier nozzle 32 and at least one cleaning nozzle 34. The carrier nozzle 32 delivers a stream 36 of carrier fluid 38 within an area below the air filter 16 and below the filter media 26. The at least one cleaning nozzle 34 directs a cleaning stream 40 of fluid 42 onto the filter media 26. The cleaning nozzle 34 is activated after the carrier nozzle 32 has been activated. In this manner, the cleaning stream 40 of fluid 42 from the cleaning nozzle 34 operates to direct the captured particulate 14 into the stream 36 of carrier fluid 38 that is actively moved below the air filter 16 and the filter media 26. The sump 18 is positioned within the appliance 12 to receive the stream 36 of carrier fluid 38 along with the cleaning stream 40 of the fluid 42 as well as the captured particulate 14 that is moved within the stream 36 of carrier fluid 38. According to various aspects of the device, the stream 36 of carrier fluid 38 is delivered from the carrier nozzle 32 and through a carrier channel 44 that is positioned below the filter media 26 and below the air filter 16. In this manner, the carrier channel 44 defines a collection area 46 into which the captured particulate 14 is moved through operation of the cleaning stream 40 of fluid 42 from the at least one cleaning nozzle 34.

According to the various aspects of the device, as exemplified in FIGS. 1-14, the stream 36 of carrier fluid 38 moves through the carrier channel 44 in advance of activation of the at least one cleaning nozzle 34. Accordingly, the stream 36 of carrier fluid 38 eliminates friction within the carrier channel 44 and prevents the captured particulate 14 from adhering to the surface of the carrier channel 44. The movement of the stream 36 of carrier fluid 38 also provides a biasing force that directs the captured particulate 14 that falls into the carrier channel 44 toward the sump 18. Once the captured particulate 14 is within the sump 18, the captured particulate 14 can be processed, collected, or otherwise circulated for later disposal to a drain or through certain processes to eliminate the captured particulate 14 from the appliance 12.

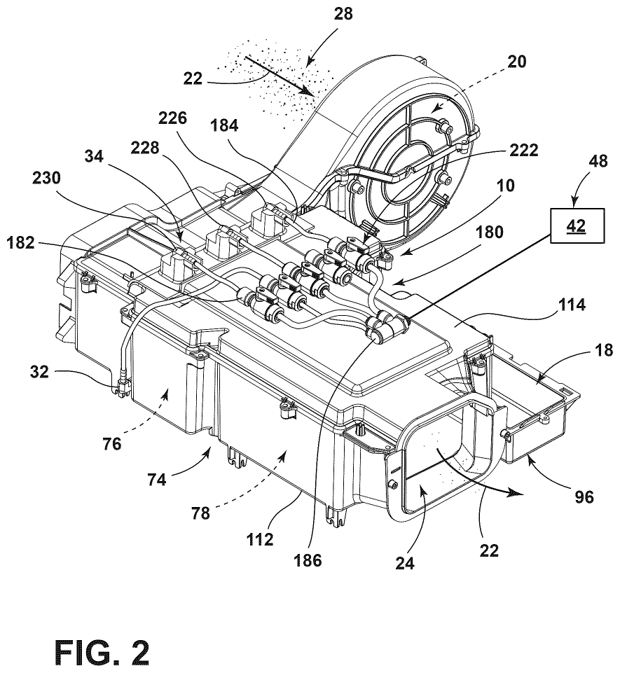

Referring to FIGS. 2-14, during operation of a particular spray sequence 60, the carrier nozzle 32 is activated as an initial step, or one of the initial steps, of the spray sequence 60. After the carrier nozzle 32 has been activated to create the stream 36 of carrier fluid 38 within the carrier channel 44, the cleaning nozzle 34, or a plurality of cleaning nozzles 34, are activated to move captured particulate 14 away from the filter media 26. As described herein, the captured particulate 14 is pushed into the stream 36 of carrier fluid 38 within the carrier channel 44. The force of the stream 36 of carrier fluid 38 moves the captured particulate 14 through the carrier channel 44 and toward the sump 18. After the operation of the cleaning nozzles 34 is complete, the carrier nozzle 32 is then deactivated. Through this process, as the captured particulate 14 falls away from, or is pushed away from, the filter media 26, the stream 36 of carrier fluid 38 is actively operated to move the captured particulate 14 through the carrier channel 44 and into the sump 18 of the appliance 12.

Referring to FIGS. 1-3, the appliance 12 includes the airflow path 24 that extends from the blower 20 and into a processing chamber 70 of the appliance 12. Typically, this processing chamber 70 will be within a rotating drum 72 or other similar processing space for treating articles. Using the process air 22 that is delivered by the blower 20, laundry or other articles can be dehumidified, conditioned, or otherwise treated within the processing space. The process air 22 moves from the processing space and into a heat exchanger housing 74 that includes an evaporator 76 for cooling and dehumidifying the humidified process air 22, and a condenser 78 for reheating the process air 22 to be recycled back into the processing space of the appliance 12.

Referring again to FIGS. 2-14, upstream of the evaporator 76, the air filter 16 is positioned to separate particulate 28 from the process air 22. The particulate 28 is separated from the process air 22 by the air filter 16 and the filter media 26 to define the captured particulate 14 that collects on the upstream surface 30 of the filter media 26. The air filter 16 operates to prevent particulate 28 from collecting on the evaporator 76, thereby diminishing the effectiveness of the evaporator 76 over time. The heat exchanger housing 74 includes various flow channels 90 that operate to collect condensate 92 that is precipitated from the process air 22 through operation of the evaporator 76. As the evaporator 76 cools the process air 22, humidity within the process air 22 precipitates into condensate 92 and collects within the flow channels 90 that are defined within a bottom wall 94 of the heat exchanger housing 74. These flow channels 90 direct the captured condensate 92 and direct this captured condensate 92 into the sump 18 that is attached to the heat exchanger housing 74. The sump 18 can include a fluid delivery device, such as a drain pump 96, that moves the captured condensate 92, and, in certain aspects of the device, the captured particulate 14 away from the sump 18 and into a separate part of the appliance 12 or to a separate external drain outside of the appliance 12. The carrier channel 44 and the flow channels 90 are sloped to utilize the force of gravity to assist in directing the carrier fluid 38, the captured particulate 14, and the captured condensate 92 into the sump 18.

According to various aspects of the device, the carrier fluid 38 and cleaning stream 40 of fluid 42 that are delivered to the sump 18 can be filtered from the captured particulate 14 and recycled through the fluid spray system 10 for operating a carrier phase 200 and a cleaning phase 202 of the spray sequence 60 of the fluid spray system 10. It is also contemplated that the fluid 42 used for the fluid spray system 10 can be from an external fluid source, or from a reservoir disposed within the appliance 12.

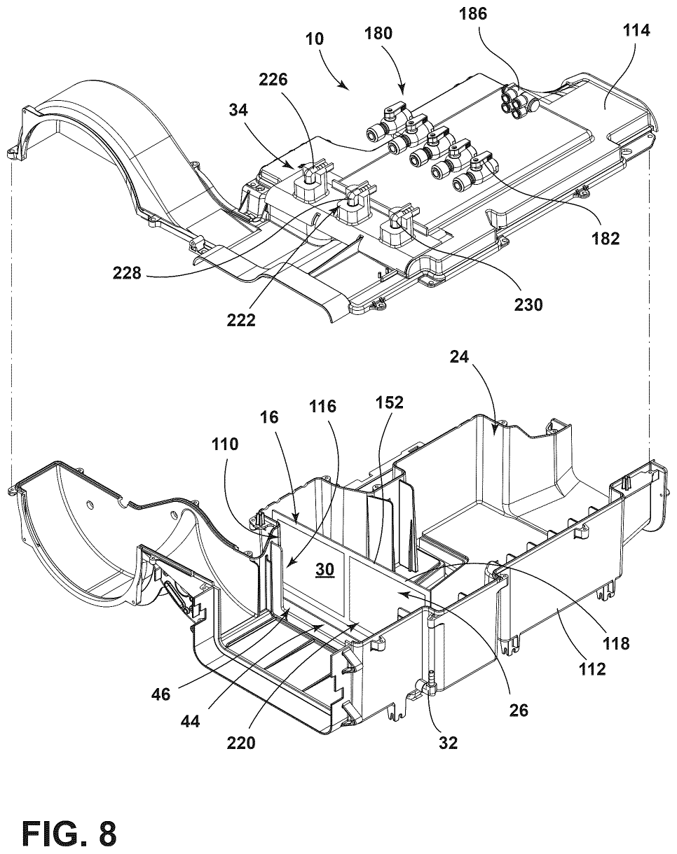

Referring again to FIGS. 8-13, the air filter 16 is disposed within a filter receptacle 110 defined within a lower portion 112 of the heat exchanger housing 74, which is sometimes referred to as a basement structure. The filter receptacle 110 extends around the perimeter of the air filter 16 and secures the air filter 16 within the airflow path 24. The filter receptacle 110 cooperates with the air filter 16 to prevent the process air 22 from moving around the filter media 26. Accordingly, the filter receptacle 110 assists in directing all of the process air 22 through the air filter 16 for capturing particulate 28 within the process air 22. The carrier channel 44 is positioned adjacent to the filter receptacle 110. In certain aspects of the device, the carrier channel 44 can define a portion of the filter receptacle 110 such that the carrier channel 44 can be positioned to capture a maximum amount of the captured particulate 14 that is moved off from the filter media 26 through operation of the cleaning stream 40 of fluid 42 from the one or more cleaning nozzles 34. The lower portion 112 of the heat exchanger housing 74 is opposed by an upper portion 114 of the heat exchanger housing 74. The lower portion 112 and the upper portion 114 can each define a part of the filter receptacle 110. Accordingly, the filter receptacle 110 surrounds the air filter 16 to secure the air filter 16 in the airflow path 24 and to create a seal 116 around an outer edge 118 of the air filter 16.

Referring again to FIGS. 2-13, the carrier nozzle 32 and the carrier channel 44 are positioned below a lower edge 130 of the air filter 16. In this position, the carrier nozzle 32 directs the stream 36 of carrier fluid 38 within the carrier channel 44 and below the air filter 16. Through this configuration, the stream 36 of carrier fluid 38 is able to continuously move captured particulate 14 that falls within the carrier channel 44 toward the sump 18. Accordingly, due to the continuous movement, or substantially continuous movement, of the carrier fluid 38 through the carrier channel 44, the captured particulate 14 is not able to accumulate within the carrier channel 44. In this manner, the captured particulate 14 collected on the filter media 26 is typically delivered as small portions of the captured particulate 14 into the carrier channel 44 and moved along the carrier channel 44 to the sump 18. By continuously moving the stream 36 of carrier fluid 38 through the carrier channel 44, the captured particulate 14 is not able to accumulate within the carrier channel 44, thereby mitigating or eliminating the occurrence of clogs or other blockages of captured particulate 14 within the carrier channel 44. Additionally, use of the stream 36 of carrier fluid 38 is able to divide, portion, or otherwise regulate the movement of the captured particulate 14 into the sump 18. In this manner, the sump 18 is able to manage the influx of captured particulate 14 through the carrier channel 44 for convenient disposal of the captured particulate 14 from the appliance 12.

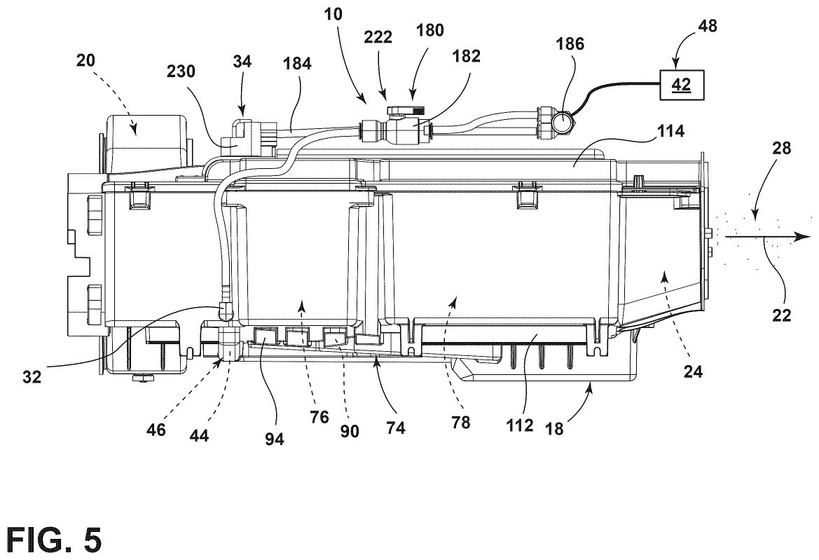

Referring again to FIGS. 5-13, the carrier channel 44 includes a sloped portion 140 that is positioned below the air filter 16 and the filter media 26. As described herein, this sloped portion 140 assists in directing the carrier fluid 38 and the captured particulate 14 through the carrier channel 44 and toward the sump 18. Using the sloped portion 140, the stream 36 of carrier fluid 38 is able to flow through the carrier channel 44 to provide a biasing force that moves the captured particulate 14 toward the sump 18. It is contemplated that during a spray sequence 60, the carrier nozzle 32 can operate continuously to define a continuous stream 36 of the carrier fluid 38 that moves through the carrier channel 44 while one or more of the cleaning nozzles 34 are in operation. It is also contemplated that the carrier nozzle 32 can operate intermittently, such as through pulsations, periodic activations and deactivations, and other similar activating patterns to produce the stream 36 of carrier fluid 38 that moves through the carrier channel 44. In each of these patterns of activation, the stream 36 of carrier fluid 38 is continuously present within the carrier channel 44 during operation of the cleaning nozzles 34. In this manner, as the captured particulate 14 falls into the carrier channel 44, a stream 36 of carrier fluid 38 is present to assist in the movement of the captured particulate 14 through the carrier channel 44 and into the sump 18.

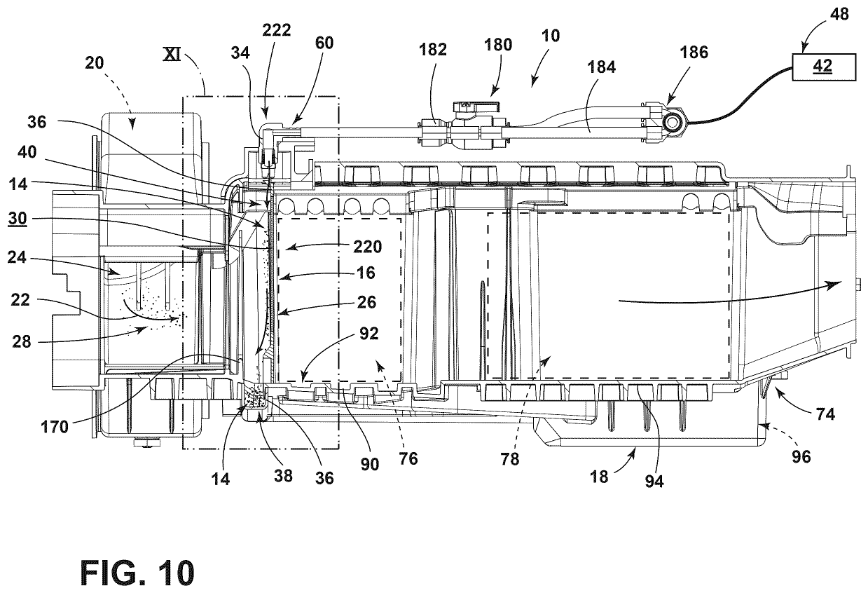

Referring now to FIGS. 10-12, the air filter 16 can include a deflecting member 150 that is positioned within a frame 152 of the air filter 16 and below the filter media 26. This deflecting member 150 includes an angled surface 154 that is positioned to deflect the cleaning stream 40 of fluid 42 away from the upstream surface 30 of the filter media 26 and the frame 152 for the air filter 16 and into the carrier channel 44. In this manner, during operation of the cleaning nozzles 34, the cleaning streams 40 of fluid 42 are directed along the upstream surface 30 of the filter media 26. The cleaning nozzles 34 are typically directed either parallel with the upstream surface 30 of the filter media 26 or at a minimal angle with respect to the upstream surface 30 of the filter media 26. Through this configuration, the cleaning streams 40 are able to maneuver between the upstream surface 30 of the filter media 26 and the accumulated layer or layers of captured particulate 14. In this manner, the cleaning stream 40 of fluid 42 for separating the captured particulate 14 from the upstream surface 30 of the filter media 26. The cleaning stream 40 of fluid 42, in turn, directs the captured particulate 14 in a generally downward direction toward the carrier channel 44. Use of the deflecting member 150 acts to further separate the captured particulate 14 from the filter media 26 and the frame 152 for the air filter 16 to direct the captured particulate 14 into the carrier channel 44.

Referring again to FIGS. 10-12, the carrier channel 44 can include a guide wall 170 that is positioned opposite the air filter 16 and near the deflecting member 150 of the air filter 16. Through this guide wall 170, captured particulate 14 and the cleaning stream 40 of fluid 42 that are redirected by the deflecting member 150 can engage the guide wall 170 and fall into the carrier channel 44. The guide wall 170 operates to prevent overflow and splashing of the cleaning stream 40 and the stream 36 of carrier fluid 38 out from the carrier channel 44. Once in the carrier channel 44, as described herein, the stream 36 of carrier fluid 38 that is moving through the carrier channel 44 immediately biases the captured particulate 14 for movement through the carrier channel 44 and toward the sump 18.

Referring again to FIGS. 2-14, it is contemplated that the stream 36 of carrier fluid 38 and cleaning stream 40 that is directed through the cleaning nozzles 34 are delivered through the fluid spray system 10 from a common fluid source 48. This common fluid source 48 can include a reservoir (not shown) that is disposed within the appliance 12, or can be an outside fluid source 48, such as a pump or municipal water supply. Where a reservoir is disposed within the appliance 12, this reservoir can be filled with captured condensate 92 that has been collected through a current drying cycle or through previous drying cycles. Accordingly, the sump 18 can be used to collect captured condensate 92 and redirect this captured condensate 92 to the reservoir for later use within the appliance 12.

Referring again to FIGS. 2-14, a valve assembly 180 is attached to the heat exchanger housing 74 and is utilized for directing fluid 42 from the fluid source 48 and to the carrier nozzle 32 and the cleaning nozzles 34 of the fluid spray system 10. Various valves 182 of the valve assembly 180 can include valves 182 that deliver fluid 42 to the one or more cleaning nozzles 34 as well as fluid 42 to the carrier nozzle 32. Fluid conduits 184 (schematically illustrated) can extend from the fluid source 48 and to a distribution fitting 186. The distribution fitting 186 divides the fluid 42 among the various valves 182 and, in turn, to the corresponding carrier nozzle 32 and cleaning nozzles 34 of the fluid spray system 10. Through this configuration, the valve assembly 180 is configured to operate the at least one cleaning nozzle 34 while the valve assembly 180 is delivering the fluid 42 to the carrier nozzle 32. Stated another way, during a spray sequence 60, the valve assembly 180 first activates the carrier nozzle 32 to produce the stream 36 of carrier fluid 38 within the carrier channel 44.

Referring again to FIGS. 2-14, subsequently, after the carrier nozzle 32 is activated and the stream 36 of carrier fluid 38 is actively moving through the carrier channel 44, the valve assembly 180 activates the one or more cleaning nozzles 34 to separate the captured particulate 14 from the filter media 26. The captured particulate 14 is thereby disposed into the carrier channel 44. Again, the stream 36 of carrier fluid 38 is already moving through the carrier channel 44. In this manner, the carrier nozzle 32 operates during a carrier phase 200. During this carrier phase 200, the at least one cleaning nozzle 34 operates during a cleaning phase 202. The cleaning phase 202 of the various cleaning nozzles 34 operate during the performance of the carrier phase 200 of the fluid spray system 10. Accordingly, the carrier phase 200 begins before the cleaning phase 202. Additionally, the carrier phase 200 ends after the cleaning phase 202 is completed. Because the carrier phase 200 happens throughout the cleaning phase 202, the stream 36 of carrier fluid 38 is present and actively moving through the carrier channel 44 during the entire operation of the one or more cleaning nozzles 34 of the fluid spray system 10.

Referring again to FIGS. 1-14, an air filtration assembly 220 for the appliance 12 includes the filter media 26 that is disposed within the airflow path 24. The filter media 26 separates the particulate 28 from the process air 22 that is present within the airflow path 24 to define captured particulate 14 that collects on the upstream surface 30 of the filter media 26. The carrier channel 44 is positioned below the filter media 26. The carrier nozzle 32 is aligned with the carrier channel 44. The carrier nozzle 32 is selectively operable to direct the stream 36 of carrier fluid 38 through the carrier channel 44 and below the filter media 26. A filter cleaning assembly 222 directs the cleaning stream 40 of the fluid 42 onto the filter media 26 for directing the captured particulate 14 off from the filter media 26 and into the carrier channel 44. The filter cleaning assembly 222 is activated only after activation of the carrier nozzle 32. The carrier nozzle 32 is deactivated after deactivation of the filter cleaning assembly 222. The sump 18 is in communication with the carrier channel 44. In this manner, the sump 18 receives the stream 36 of carrier fluid 38, the cleaning stream 40, and the captured particulate 14 from the carrier channel 44.

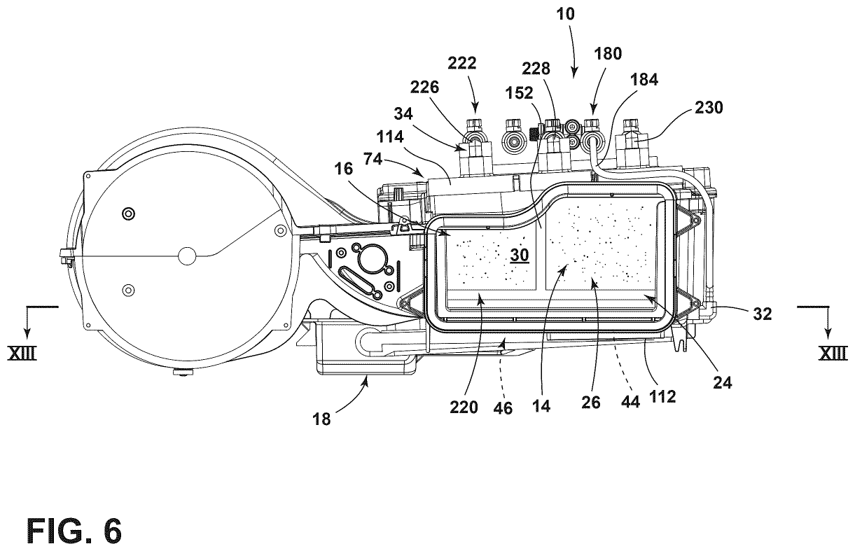

Referring again to FIGS. 6-13, the filter media 26 is disposed within the filter receptacle 110 of the airflow path 24. The filter cleaning assembly 222 and the carrier nozzle 32 are attached to an outer surface of the heat exchanger housing 74 that defines the airflow path 24. In this manner, the filter cleaning assembly 222 and the carrier nozzle 32 are placed in a fixed position with respect to the airflow path 24, the filter media 26, and the carrier channel 44.

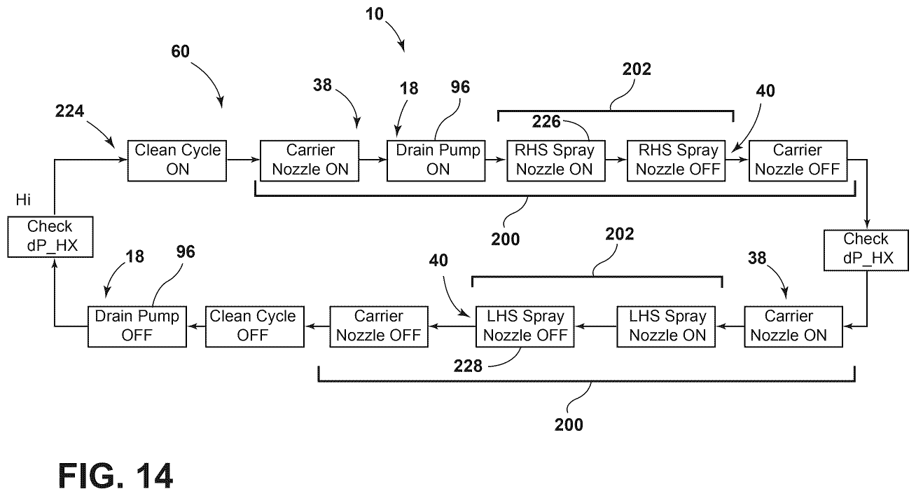

Referring now to FIG. 14, an exemplary spray sequence 60 is disclosed for operating the fluid spray system 10 of the appliance 12. According to the spray sequence 60, a filter cleaning cycle 224 for cleaning the filter media 26 is activated. During a carrier phase 200 of the filter cleaning cycle 224, the carrier nozzle 32 is activated to produce the stream 36 of carrier fluid 38 within the carrier channel 44. A drain pump 96 that is attached to the sump 18 is also activated to move the carrier fluid 38 and, eventually, captured particulate 14, away from the sump 18. A first cleaning nozzle 226 of the filter cleaning assembly 222 is then activated during a cleaning phase 202 of the filter cleaning cycle 224. As described herein, the first cleaning nozzle 226 directs the cleaning stream 40 of the fluid 42 toward the filter media 26 and separates the captured particulate 14 from the filter media 26 for deposition into the carrier channel 44. The first cleaning nozzle 226 is then deactivated. After deactivating the first cleaning nozzle 226, the carrier nozzle 32 is then deactivated.

Referring again to FIG. 14, after completion of this portion of the filter cleaning cycle 224, the appliance 12 operates a check of the evaporator 76, the condenser 78 and other components of the heat exchanger system to determine whether the process air 22 is moving effectively through the heat exchanger housing 74. Where limited amounts of process air 22 are moving through the heat exchanger housing 74, or the evaporator 76 and/or the condenser 78 are less efficient, this can be indicative of an accumulation of captured particulate 14 on the filter media 26.

Referring still to FIG. 14, the spray sequence 60 continues by reactivating the carrier nozzle 32 to reintroduce the stream 36 of carrier fluid 38 into the carrier channel 44. A second cleaning nozzle 228 is then activated to direct a cleaning stream 40 of fluid 42 onto a separate portion of the filter media 26 and to remove captured particulate 14 from that separate portion of the filter media 26. After a certain amount of time passes, the second cleaning nozzle 228 is deactivated to stop the cleaning stream 40 of the fluid 42. The carrier nozzle 32 is then deactivated after the carrier fluid 38 has moved the captured particulate 14 through the carrier channel 44 and to the sump 18. After the carrier nozzle 32 is deactivated, the spray sequence 60 is deactivated and the drain pump 96 within the sump 18 is also deactivated.

As exemplified in FIGS. 2-14, the fluid spray system 10 can include additional cleaning nozzles 34, such as a third cleaning nozzle 230. It is contemplated that the various cleaning nozzles 34 can be positioned above the air filter 16 for cleaning dedicated portions of the filter media 26. Depending upon the size and configuration of the air filter 16, the various cleaning nozzles 34 can be positioned to direct the cleaning streams 40 of fluid 42 to provide sufficient coverage to fully separate the captured particulate 14 from the upstream surface 30 of the filter media 26. As indicated in FIG. 14, operation of the spray sequence 60 can include dedicated carrier phases 200. Within each carrier phase 200, a respective cleaning phase 202 can be performed.

According to the various aspects of the device, the particular filter media 26 that is incorporated within the air filter 16 can include any of various materials. These materials can include, but are not limited to, a filter mesh, foam filters, a filtering screen, combinations thereof, and other similar filtering materials. Typically, the air filter 16 that is disposed within the filter receptacle 110 is not removable from the heat exchanger housing 74. Use of the fluid spray system 10 is included to separate captured particulate 14 from the upstream surface 30 of the filter media 26. It is contemplated that where more intense cleaning of the filter media 26 is needed, a service technician can access the air filter 16 through an access panel, or by accessing the interior of the heat exchanger housing 74 of the appliance 12.

Referring again to FIG. 14, the appliance 12, utilizing various sensors, again monitors the airflow through the heat exchanger housing 74 to assess the amount of process air 22 that is able to pass therethrough. Where the process air 22 moves below a certain percentage of an expected airflow, or the temperature of the process air 22 is not at a desired target temperature, the appliance 12 can reactivate the spray sequence 60 to again remove captured particulate 14 from the filter media 26. Typically, the spray sequence 60 will activate at the conclusion of each operation cycle. It is also contemplated that a spray sequence 60 can occur during performance of an operating cycle within the appliance 12.

The various sensors that monitor the movement, temperature, humidity, and other characteristics of the process air 22 moving through the heat exchanger housing 74 can include airflow sensors, temperature sensors, and other similar sensors that can monitor data points related to the movement of process air 22 through the heat exchanger housing 74 and the efficiency of the evaporator 76, the condenser 78, and the appliance 12 in general.

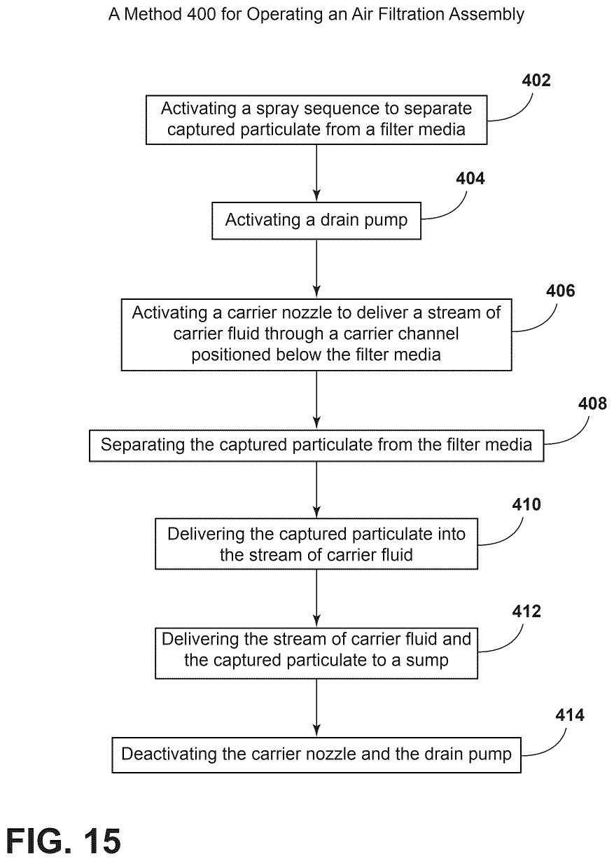

Referring now to FIGS. 1-15, having described various aspects of the fluid spray system 10 and the active carrier channel 44, a method 400 is disclosed for operating an air filtration assembly 220. The method 400 includes a step 402 for activating a spray sequence 60 to separate captured particulate 14 from the filter media 26. Once activated, a drain pump 96 is activated for delivering carrier fluid 38 and captured particulate 14 to a separate portion of the appliance 12 (step 404). According to the spray sequence 60, a carrier nozzle 32 is then activated to deliver a stream 36 of carrier fluid 38 through the carrier channel 44 that is positioned below the filter media 26 (step 406). The appliance 12 operates to separate captured particulate 14 from the filter media 26 (step 408). The separation of the captured particulate 14 from the filter media 26 can occur, as described herein, through one or more cleaning nozzles 34. This separation can also occur through various mechanisms such as wipers, brushes, airstreams, and other similar mechanisms that can bias, or otherwise separate, the captured particulate 14 from the filter media 26. The captured particulate 14 is then delivered into the stream 36 of carrier fluid 38 within the carrier channel 44 (step 410). The stream 36 of carrier fluid 38 and the captured particulate 14 are delivered to the sump 18 (step 412). At the conclusion of the spray sequence 60, the carrier nozzle 32 and the drain pump 96 are deactivated (step 414).

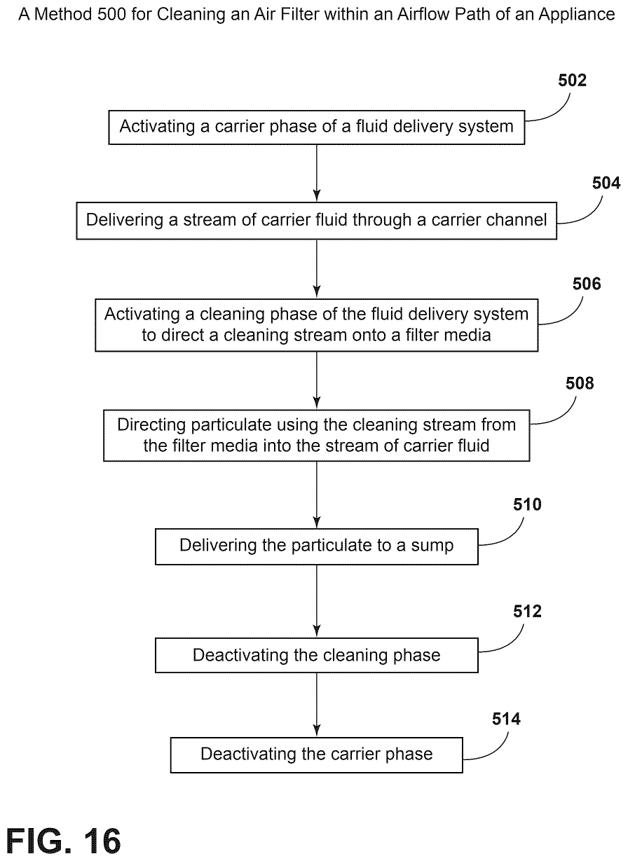

Referring now to FIGS. 1-14 and 16, having described various aspects of the fluid spray system 10 and the active carrier channel 44, a method 500 is disclosed for cleaning an air filter 16 within an airflow path 24 for an appliance 12. According to the method 500, a step 502 includes activating a carrier phase 200 of a fluid spray system 10. As described herein, once the carrier phase 200 is activated, a stream 36 of carrier fluid 38 is delivered through the carrier channel 44 (step 504). The cleaning phase 202 of the fluid spray system 10 is then activated to direct the cleaning stream 40 of fluid 42 onto the filter media 26 (step 506). The captured particulate 14 is then directed using the cleaning stream 40 from the filter media 26 and into the stream 36 of carrier fluid 38 within the carrier channel 44 (step 508). The captured particulate 14 is then delivered to the sump 18 (step 510). The cleaning phase 202 can then be deactivated (step 512). At the conclusion of the spray sequence 60, the carrier phase 200 is then deactivated (step 514). As described herein, at the conclusion of the cleaning phase 202, the cleaning nozzles 34 are deactivated. Similarly, at the conclusion of the carrier phase 200, the carrier nozzle 32 is deactivated.

According to various aspects of the device, use of the carrier channel 44, the carrier nozzle 32, and the stream 36 of carrier fluid 38 moving through the carrier channel 44 provides a continuous flow of fluid 42 that receives the captured particulate 14 from the filter media 26. The carrier fluid 38 immediately moves this captured particulate 14 toward the sump 18 for disposal. Use of the stream 36 of carrier fluid 38 provides for a portioned delivery of the captured particulate 14 through the carrier channel 44 to prevent clogs and unwanted accumulations of captured particulate 14 within the carrier channel 44 and within the sump 18. Because the captured particulate 14 is moved in a regulated fashion through the stream 36 of carrier fluid 38, the sump 18 and the drain pump 96 are able to dispose of the captured particulate 14 in a similarly regulated fashion. Accordingly, through the use of the stream 36 of carrier fluid 38 directed by the carrier nozzle 32, captured particulate 14 is prevented from being or remaining stagnant within the carrier channel 44. The captured particulate 14, using the stream 36 of carrier fluid 38, is continuously moved through the carrier channel 44 and toward the sump 18. Once in the sump 18, the captured particulate 14 remains in continuous motion, or substantially continuous motion. Accordingly, accumulations of captured particulate 14 are unable to take hold on a surface of the carrier channel 44 or the sump 18 due to the continuous movement of fluid 42 through the carrier channel 44 during a cleaning phase 202 of the fluid spray system 10.

According to one aspect of the present disclosure, a laundry appliance includes a blower that delivers process air through an airflow path, an air filter having a filter media that separates particulate from the process air to define captured particulate, a fluid spray system having at least one cleaning nozzle and a carrier nozzle, and a sump that receives the stream of carrier fluid, the cleaning stream and the captured particulate. The carrier nozzle delivers a stream of carrier fluid below the air filter, and the at least one cleaning nozzle directs a cleaning stream onto the filter media. The cleaning nozzle operates after activation of the carrier nozzle to direct the captured particulate into the stream of carrier fluid.

According to another aspect, the stream of carrier fluid is delivered through a carrier channel that is positioned below the filter media.

According to another aspect, the carrier nozzle is deactivated after each nozzle of the at least one cleaning nozzle is deactivated.

According to another aspect, the air filter is disposed within a filter receptacle of a basement structure, wherein the at least one cleaning nozzle and the carrier nozzle are attached to the basement structure.

According to another aspect, the carrier nozzle is positioned below a lower edge of the air filter and directs the stream of carrier fluid below the air filter and into the carrier channel.

According to another aspect, the carrier channel includes a sloped portion that is positioned below the filter media, wherein the sloped portion assists in directing the captured particulate toward the sump.

According to another aspect, the air filter includes a deflecting member positioned below the filter media, the deflecting member positioned to deflect the cleaning stream and the captured particulate into the stream of carrier fluid.

According to another aspect, the stream of carrier fluid and the cleaning stream are delivered through the fluid spray system from a common fluid source.

According to another aspect, a valve assembly directs fluid from a fluid source to the carrier nozzle and the at least one cleaning nozzle.

According to another aspect, the valve assembly is configured to operate the at least one cleaning nozzle while the valve assembly is delivering the fluid to the carrier nozzle.

According to another aspect, the carrier nozzle operates during a carrier phase, and wherein the at least one cleaning nozzle operates during a cleaning phase, wherein the cleaning phase occurs within the carrier phase.

According to another aspect, the fluid spray system receives fluid from an external fluid source.

According to another aspect of the present disclosure, an air filtration assembly for an appliance includes a filter media disposed within an airflow path. The filter media separates particulate from process air within the airflow path to define captured particulate. The air filtration assembly also includes a carrier channel positioned below the filter media, and a carrier nozzle aligned with the carrier channel. The carrier nozzle is selectively operable to direct a stream of carrier fluid through the carrier channel and below the filter media. The air filtration assembly further includes a filter cleaning assembly that directs a cleaning stream onto the filter media for directing the captured particulate into the carrier channel. The filter cleaning assembly is activated only after activation of the carrier nozzle, and the carrier nozzle is deactivated after deactivation of the filter cleaning assembly. The air filtration assembly additionally includes a sump in communication with the carrier channel. The sump receives the stream of carrier fluid, the cleaning stream, and the captured particulate.

According to another aspect, the filter media is disposed within a filter receptacle of the airflow path, wherein the filter cleaning assembly and the carrier nozzle are attached to an outer surface of a heat exchanger housing that defines the airflow path.

According to another aspect, the carrier channel includes a sloped portion that is positioned below the filter media, wherein the sloped portion assists in directing the captured particulate toward the sump.

According to another aspect, a valve assembly directs fluid from a fluid source to the carrier nozzle and the filter cleaning assembly.

According to another aspect, the carrier nozzle operates during a carrier phase, and wherein the filter cleaning assembly operates during a cleaning phase, wherein the cleaning phase occurs within the carrier phase.

According to another aspect, the filter cleaning assembly includes a cleaning nozzle for directing the cleaning stream onto the filter media.

According to yet another aspect of the present disclosure, a method for operating an air filtration assembly includes the steps of activating a spray sequence to separate captured particulate from a filter media, activating a drain pump, activating a carrier nozzle to deliver a stream of carrier fluid through a carrier channel positioned below the filter media, separating the captured particulate from the filter media, delivering the captured particulate into the stream of carrier fluid, delivering the stream of carrier fluid and the captured particulate to a sump, and deactivating the carrier nozzle and the drain pump.

According to another aspect, the step of separating the captured particulate from the filter media is performed by a cleaning stream of fluid from at least one cleaning nozzle.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A laundry appliance comprising:
a blower that delivers process air through an airflow path;
an air filter having a filter media that separates particulate from the process air to define captured particulate;
a fluid spray system having at least one cleaning nozzle and a carrier nozzle, wherein the carrier nozzle delivers a stream of carrier fluid below the air filter, and wherein the at least one cleaning nozzle directs a cleaning stream onto the filter media, the cleaning nozzle operating after activation of the carrier nozzle to direct the captured particulate into the stream of carrier fluid; and
a sump that receives the stream of carrier fluid, the cleaning stream, and the captured particulate.

2. The laundry appliance of claim 1, wherein the stream of carrier fluid is delivered through a carrier channel that is positioned below the filter media.

3. The laundry appliance of claim 1, wherein the carrier nozzle is deactivated after each nozzle of the at least one cleaning nozzle is deactivated.

4. The laundry appliance of claim 1, wherein the air filter is disposed within a filter receptacle of a basement structure, wherein the at least one cleaning nozzle and the carrier nozzle are attached to the basement structure.

5. The laundry appliance of claim 2, wherein the carrier nozzle is positioned below a lower edge of the air filter and directs the stream of carrier fluid below the air filter and into the carrier channel.

6. The laundry appliance of claim 2, wherein the carrier channel includes a sloped portion that is positioned below the filter media, wherein the sloped portion assists in directing the captured particulate toward the sump.

7. The laundry appliance of claim 1, wherein the air filter includes a deflecting member positioned below the filter media, the deflecting member positioned to deflect the cleaning stream and the captured particulate into the stream of carrier fluid.

8. The laundry appliance of claim 1, wherein the stream of carrier fluid and the cleaning stream are delivered through the fluid spray system from a common fluid source.

9. The laundry appliance of claim 1, further comprising:
a valve assembly that directs fluid from a fluid source to the carrier nozzle and the at least one cleaning nozzle.

10. The laundry appliance of claim 9, wherein the valve assembly is configured to operate the at least one cleaning nozzle while the valve assembly is delivering the fluid to the carrier nozzle.

11. The laundry appliance of claim 1, wherein the carrier nozzle operates during a carrier phase, and wherein the at least one cleaning nozzle operates during a cleaning phase, wherein the cleaning phase occurs within the carrier phase.

12. The laundry appliance of claim 1, wherein the fluid spray system receives fluid from an external fluid source.

13. An air filtration assembly for an appliance, the air filtration assembly comprising:
a filter media disposed within an airflow path, wherein the filter media separates particulate from process air within the airflow path to define captured particulate;
a carrier channel positioned below the filter media;
a carrier nozzle aligned with the carrier channel, the carrier nozzle selectively operable to direct a stream of carrier fluid through the carrier channel and below the filter media;
a filter cleaning assembly that directs a cleaning stream onto the filter media for directing the captured particulate into the carrier channel, wherein the filter cleaning assembly is activated only after activation of the carrier nozzle, and wherein the carrier nozzle is deactivated after deactivation of the filter cleaning assembly; and
a sump in communication with the carrier channel, wherein the sump receives the stream of carrier fluid, the cleaning stream, and the captured particulate.

14. The air filtration assembly of claim 13, wherein the filter media is disposed within a filter receptacle of the airflow path, wherein the filter cleaning assembly and the carrier nozzle are attached to an outer surface of a heat exchanger housing that defines the airflow path.

15. The air filtration assembly of claim 13, wherein the carrier channel includes a sloped portion that is positioned below the filter media, wherein the sloped portion assists in directing the captured particulate toward the sump.

16. The air filtration assembly of claim 13, further comprising:
a valve assembly that directs fluid from a fluid source to the carrier nozzle and the filter cleaning assembly.

17. The air filtration assembly of claim 13, wherein the carrier nozzle operates during a carrier phase, and wherein the filter cleaning assembly operates during a cleaning phase, wherein the cleaning phase occurs within the carrier phase.

18. The air filtration assembly of claim 13, wherein the filter cleaning assembly includes a cleaning nozzle for directing the cleaning stream onto the filter media.

19. A method for operating an air filtration assembly, the method comprising steps of:
activating a spray sequence to separate captured particulate from a filter media;
activating a drain pump;
activating a carrier nozzle to deliver a stream of carrier fluid through a carrier channel positioned below the filter media;
separating the captured particulate from the filter media;
delivering the captured particulate into the stream of carrier fluid;
delivering the stream of carrier fluid and the captured particulate to a sump; and
deactivating the carrier nozzle and the drain pump.

20. The method of claim 19, wherein the step of separating the captured particulate from the filter media is performed by a cleaning stream of fluid from at least one cleaning nozzle.
